(19) United States
(12) Patent Application Publication
(10) Pub. No.: US 2009/0014616 A1
(43) Pub. Date: Jan. 15, 2009

(54) STORAGE COMPARTMENT AND HOLDER FOR A BEVERAGE CONTAINER

(76) Inventor: Falk Schaal, Alpirsbach (DE)

Correspondence Address: MICHAEL J. STRIKER, 103 EAST NECK ROAD, HUNTINGTON, NY, 11743, US

(21) Appl. No.: 12/167,514

(22) Filed: Jul. 3, 2008

(30) Foreign Application Priority Data
Jul. 11, 2007 (DE) 10 2007 032 205.6

(51) Int. Cl. B60N 3/10

(52) U.S. Cl. 248/311.2

(57) ABSTRACT

A storage compartment for a beverage container for a motor vehicle is constructed in form of two intersecting circles in plan view, and a compartment divider is inserted rotatably into one of the two circles, which compartment divider is in the shape of a cylindrical tube and has a recess at a peripheral location. By rotation of the compartment divider, the size of the holder for a beverage container in the storage compartment can be changed. By removal of the compartment divider, the full extent of the storage compartment can be utilised. In addition, the compartment divider can be exchanged for other compartment dividers.

### CROSS-REFERENCE TO A RELATED APPLICATION

The invention described and claimed hereinbelow is also described in German Patent Application DE 10 2007 032 205.6 filed on Jul. 11, 2007. This German Patent Application, whose subject matter is incorporated here by reference, provides the basis for a claim of priority of invention under 35 U.S.C. 119(a)-(d).

### BACKGROUND OF THE INVENTION

The invention relates to a storage compartment and holder for a beverage container.

The storage compartment and holder is intended for installation in a motor vehicle or alternatively in some other land vehicle, aircraft or watercraft. Beverage containers are, for example, a beverage can, a beaker, a cup or a bottle.

Patent application JP-A-09104278 discloses a holder for two beverage containers, having the form of a box which is rectangular in plan view and is open at the top. A compartment divider is mounted in the center of a longitudinal side wall so as to be rotatable about a notional vertical axis. Terms such as “top” and “vertical” relate to the intended installation and in-use position of the holder. The compartment divider takes the form of a horizontally arranged disc composed of a relatively large semicircle and a relatively small semicircle. The disc forming the compartment divider is arranged in a slot in the longitudinal side wall of the box-shaped holder.

By rotation, the small semicircle or the large semicircle can be pivoted into the box-shaped holder, the respective other semicircle being located outside the holder. Also possible are two rotated positions in which a quarter of the large semicircle and a quarter of the small semicircle project into the box-shaped holder. In the different rotated positions, the compartment divider projects into the holder by different amounts and leaves different amounts of free space between itself and the two respective diagonally opposite corners, into which a beverage container can be inserted. By means of the different rotated positions of the compartment divider, two different sizes can be established and the holder can be matched to beverage containers of different diameters.

### SUMMARY OF THE INVENTION

The problem underlying the invention is to propose a storage compartment and holder for a beverage container having a compartment divider which is structurally different and allows the whole storage compartment to be utilised as a storage compartment.

In keeping with these objects and with others which will become apparent hereinafter, one feature of the present invention recites, briefly stated, in a storage compartment for a beverage container, comprising a housing having a compartment part provided with a depression; a compartment divider which is rotatably arranged in said depression, so that in one rotated position said compartment divider projects into the region of said depression that forms a holder for a beverage container, and in another position it projects into said region at least to a lesser extent, said compartment divider being configured so that it is removable from said depression of said compartment part.

The storage compartment according to the invention has, in particular, an elongate shape; for example, in plan view it is oval or has the shape of two intersecting circles. A rectangular shape, for example, is also possible. One region of the storage compartment, especially a circular or square end region of the storage compartment, forms the holder for a beverage container, which holder is delimited with respect to the remainder of the storage compartment and completed to form the holder by a rotatable compartment divider. A wall of the storage compartment and the compartment divider enclose an inserted beverage container, it being possible to have an unbroken enclosure or to have one or more breaks in the enclosure. In one rotated position, the compartment divider projects into the region of the storage compartment forming the holder, with the result that the holder is matched to a beverage container of relatively small diameter.

In another rotated position, the compartment divider does not project into the region of the storage compartment forming the holder or projects therein to a lesser extent. The holder is thus matched to beverage containers of relatively large diameter. According to the invention, the compartment divider can be removed from the storage compartment, so that the whole of the storage compartment is available for the insertion of articles. Apart from being able to use the full extent of the storage compartment, the ability of the compartment divider to be removed has the advantage that it can be exchanged for one or more other compartment dividers. As a result, the range of possible uses is increased.

One construction in accordance with the invention provides a substantially vertical pivot axis for the compartment divider. The compartment divider can have a cylindrical wall surface, the term “cylindrical” also being understood as including variations towards an acute truncated cone shape. A pivot bearing can thus be provided in a simple manner.

In one construction in accordance with the invention, the compartment divider is approximately the same height as the storage compartment, that is to say a voluminous body or hollow body and not simply a disc.

In one construction in accordance with the invention, the storage compartment has a part-cylindrical wall portion which at least partly surrounds the region of the storage compartment forming the holder. The part-cylindrical shell shape is matched to the shape of beverage holders that are largely cylindrical or, in more general terms, have a circular cross-section. Here too, an angular variation of the part-cylindrical shell shape towards a truncated cone shell shape is possible; an exactly cylindrical shape is not important.

One construction in accordance with the invention provides at least one recess in the periphery of the compartment divider. When the compartment divider is rotated so that the recess faces the region of the storage compartment forming the holder for the beverage container, the holder is suitable for insertion of a beverage container of large diameter. When the recess of the compartment divider is rotated away from the region of the storage compartment forming the holder, the cross-section of the holder is made smaller and the holder is suitable for insertion of a beverage container of relatively small diameter. In accordance with a development, the compartment divider has a plurality of differently sized recesses in its periphery, with the result that it can be matched to a larger number of different diameters of beverage containers.

In one construction in accordance with the invention, the spacing of the peripheral wall of the compartment divider from the pivot axis of the compartment divider changes in the peripheral direction of the compartment divider. The peripheral wall can be cylindrical or non-cylindrical; in each case it has an eccentric pivot axis. With this construction in accordance with the invention, the size of the holder can be changed steplessly within a limited range by rotation of the compartment divider, and the holder can thus be matched to different diameters of beverage containers.

In one construction in accordance with the invention, the compartment divider has on a peripheral portion, or in any case on one portion, grooves for the insertion of flat articles. For example, CD cases or even CDs can be pushed into the grooves. The storage compartment can thus be used as a holder for flat articles such as CD cases or CDs.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIGS. 1 and 2 show a perspective view of a storage compartment and holder for a beverage container according to the invention in two different positions;

FIGS. 3 to 14 show a plan view of the storage compartment and holder for a beverage container shown in FIGS. 1 and 2 with different compartment dividers in different positions in accordance with the invention.

### DESCRIPTION OF THE PREFERRED EMBODIMENTS

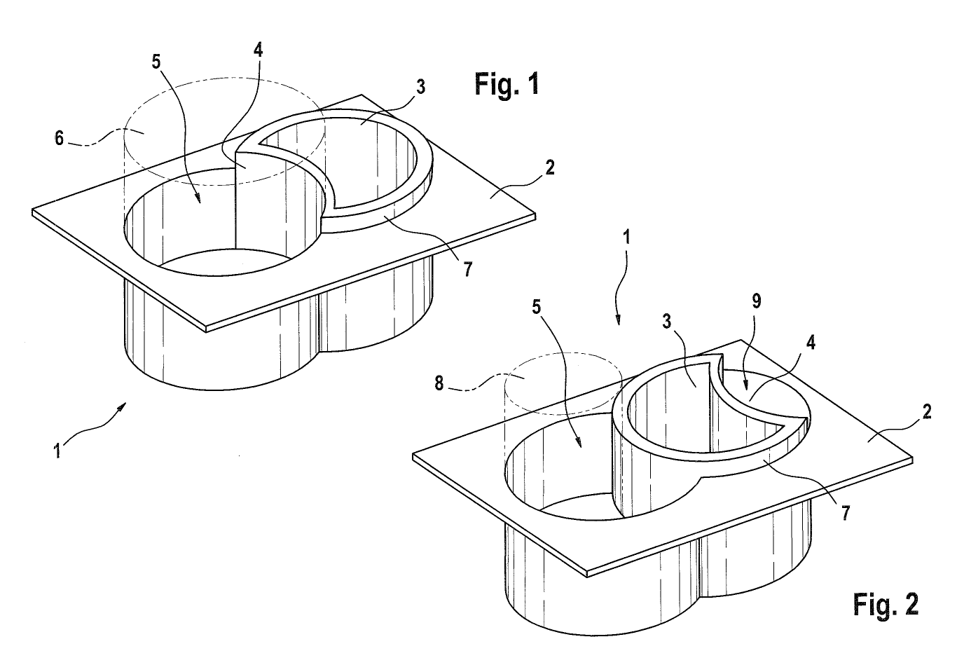

The storage compartment 1 according to the invention shown in FIGS. 1 and 2 has a pot-like depression which in plan view has the shape of two intersecting circles. An upper rim of the storage compartment 1 projects outwards as an installation panel 2 and has a rectangular outline. In one of the two circles or, more strictly, cylinders of the storage compartment 1 there is located a compartment divider 3 which takes the form of a hollow cylinder having a concave, likewise cylindrical recess 4 in a peripheral portion. The recess 4 forms an inwardly directed cylindrical bulge in the otherwise cylindrical peripheral wall of the compartment divider 3.

When, as in FIG. 1, the recess 4 of the compartment divider 3 is facing the cylindrical region of the storage compartment 1 not occupied by the compartment divider 3, the recess 4 in the periphery of the compartment divider 3 completes the region of the storage compartment 1 not occupied by the compartment divider 3 to form a hollow cylinder. The region of the storage compartment 1 not occupied by the compartment divider 3 forms a holder 5 for insertion of a beverage container 6, which is shown in the drawing as a transparent cylinder by dash-double-dotted lines. The beverage container 6 can be, for example, a beverage can, a beaker, a cup or a bottle.

The compartment divider 3 is hollow and thus forms a storage compartment. It can have a base or it can be open on its underside. The compartment divider 3 is somewhat taller than the storage compartment 1 is deep, so that it projects at the top and can be grasped by its projecting rim 7. The compartment divider 3 can be rotated in the storage compartment 1 when the beverage container 6 has been removed. As can be seen in FIG. 2, the recess 4 in the periphery of the compartment divider 3 can be rotated away from the region of the storage compartment 1 forming the holder 5 for insertion of a beverage container. In that rotated position of the compartment divider 3, the cylindrical peripheral wall of the compartment divider 3 projects a short way into the region of the storage compartment 1 forming the holder 5 for a beverage container. As a result, the compartment divider 3 reduces the size of the holder 5 for insertion of a beverage container 8 of relatively small diameter, as can be seen in FIG. 2.

The hollow compartment divider 3 can be used unchanged as a storage compartment; moreover, a region of the storage compartment 1 that is lenticular in plan view, which region is enclosed between the recess 4 of the compartment divider 3 and a peripheral wall of the storage compartment 1, forms a further storage compartment 9. The compartment divider 3 can be removed from the storage compartment 1, with the result that the full extent of the storage compartment 1 can be utilised as a storage compartment 1 (not shown).

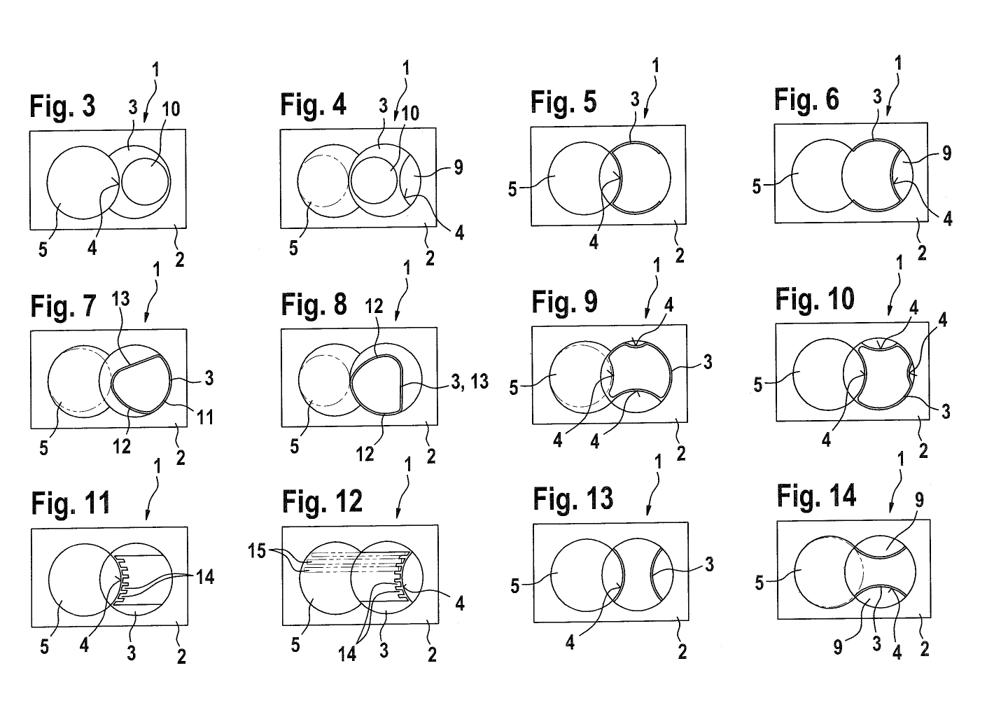

As a result of its ability to be removed, the compartment divider 3 is exchangeable. In FIGS. 3 and 4, a compartment divider 3 is inserted into the storage compartment 1 which has a cylindrical depression forming a second holder 10 for a beverage container. Otherwise the compartment divider 3 shown in FIGS. 3 and 4 is of the same construction as the compartment divider 3 shown in FIGS. 1 and 2. The compartment divider 3 shown in FIGS. 3 and 4 has a cylindrical periphery with a recess 4 at one location on the periphery. It is rotatable, so that the free cross-section of the region of the storage compartment 1 forming the holder 5 for a beverage container can be made larger or smaller, as has been explained in connection with FIGS. 1 and 2.

Unlike FIGS. 1 and 2, the compartment divider 3 in FIGS. 5 and 6 is open on a side of the periphery opposite the recess 4. When, as can be seen in FIG. 6, the open peripheral location of the compartment divider 3 is turned towards the region of the storage compartment 1 forming the holder 5 for a beverage container, the size of the storage compartment 1 is increased by the interior of the compartment divider 3. The additional storage compartment 9, which is lenticular in plan view, is available between the recess 4 of the compartment divider 3 and a peripheral wall of the storage compartment 1.

In FIGS. 7 and 8, the peripheral wall of the compartment divider 3 has a cylindrical portion 11 which is adjoined on one side by a spirally extending wall portion 12 the spacing of which from the notional center axis of the compartment divider 3 decreases. The cylindrical portion 11 and the spirally extending portion 12 are joined by a straight portion 13 which extends in a chordal direction. By rotation of the compartment divider 3, the size of the region of the storage compartment 1 forming the holder 5 for a beverage container can be adjusted steplessly within limits, as can be seen from FIGS. 7 and 8.

In FIGS. 9 and 10, the compartment divider 3 has three recesses 4 of different sizes in its periphery. By rotation of the compartment divider 3, as desired one of the three recesses 4 can be turned towards the region of the storage compartment 1 forming the holder 5 for a beverage container. The size of the region of the storage compartment 1 forming the holder 5 for a beverage container can thus be adjusted in stages.

In FIGS. 11 and 12, the compartment divider 3 is open on a side opposite the recess 4. On an inner side of the recess 4, the compartment divider 3 has grooves 14 into which flat articles such as, for example, CD cases or CDs can be pushed. When, as can be seen in FIG. 12, the recess 4 of the compartment divider 3 is remote from the region of the storage compartment 1 forming the holder 5 for a beverage container, flat articles, for example CD cases 15, as shown in FIG. 12 by dash-double-dotted lines, can be pushed into the storage compartment 1 and the grooves 14. The storage compartment 1 can thus be used as a CD holder. When the compartment divider 3 is rotated so that the recess 4 faces the region of the storage compartment 1 forming the holder 5 for a beverage container, a beverage container can be inserted. In addition, the inner region of the compartment divider 3 can be utilised as a storage compartment.

In FIGS. 13 and 14, the compartment divider 3 has only two concave cylindrical wall portions located opposite one another, which wall portions form two recesses 4. In the rotated position of the compartment divider 3 shown in FIG. 13, the region of the storage compartment 1 forming the holder 5 for insertion of a beverage container can be utilised as a holder 5. The remainder of the storage compartment 1 is divided into two smaller storage compartments. When the compartment divider 3 is rotated through 90°, as shown in FIG. 14, a long storage compartment and at the sides two small storage compartments 9, which are lenticular in plan view, are obtained.

It will be understood that each of the elements described above, or two or more together, may also find a useful application in other types of constructions differing from the types described above.

While the invention has been illustrated and described as embodied in a storage compartment and holder for a beverage container, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A storage compartment for a beverage container, comprising a housing having a storage compartment part provided with a depression; a compartment divider which is rotatably arranged in said depression, so that in one rotated position said compartment divider projects into the region of said depression that forms a holder for a beverage container, and in another position said compartment divider projects into said region at least to a lesser extent, said compartment divider being configured so that it is removable from said depression of said storage compartment part.

2. A storage compartment for a beverage container as defined in claim 1, wherein said compartment divider is rotatable about a substantially vertical pivot axis.

3. A storage compartment for a beverage container as defined in claim 1, wherein said compartment divider has a cylindrical wall surface.

4. A storage compartment for a beverage container as defined in claim 1, wherein said storage compartment part has a predetermined height, said compartment divider having a height which is substantially equal to said height of said storage compartment part.

5. A storage compartment for a beverage container as defined in claim 1, wherein said storage compartment part has a part-cylindrical-shell-shaped wall portion.

6. A storage compartment for a beverage container as defined in claim 1, wherein said compartment divider has at least one recess in its periphery.

7. A storage compartment for a beverage container as defined in claim 1, wherein said compartment divider is rotatable about a pivot axis, and has peripheral wall whose spacing from said pivot axis of said compartment divider changes in a peripheral direction.

8. A storage compartment for a beverage container as defined in claim 1, wherein said compartment divider has a storage compartment for a beverage container.

9. A storage compartment for a beverage container as defined in claim 1, wherein said compartment divider has a peripheral portion with grooves for insertion of flat articles.
